(19) United States
(12) Patent Application Publication
(10) Pub. No.: US 2008/0257130 A1
(43) Pub. Date: Oct. 23, 2008

(54) Stringed instrument construction

(76) Inventor: Jon David Kammerer, Hamilton, IL (US)

Correspondence Address: Jon D. Kammerer, 80 N. 4th St., Hamilton, IL, 62341, US

(21) Appl. No.: 11/788,022

(22) Filed: Apr. 19, 2007

(51) Int. Cl. G10D 3/00

(52) U.S. Cl. 84/291

(57) ABSTRACT

An improved hollow-bodied stringed instrument body having a substantially free edge in the lower bout which reduces the coupling of the resonances of the front plate, back plate, and enclosed volume of air. A selected number of holes of a selected shape create a substantially free edge in the lower bout of the front plate. This substantially free edge reduces the large-amplitude displacement of these plates that occurs due to low frequency resonance coupling. Placement of the free edge allows high frequency resonance of the front plate, which is not due to coupling, to contribute to the tone of the instrument. Reducing the large-amplitude displacement of the plates reduces bass-heavy tone and feedback.

### CROSS-REFERENCE TO RELATED APPLICATIONS

Not Applicable

### FEDERALLY SPONSORED RESEARCH

Not Applicable

### SEQUENCE LISTING OR PROGRAM

Not applicable

### FIELD OF THE INVENTION

This invention relates to hollow-bodied stringed instruments and, more particularly, to a new and improved body construction for such instruments.

### BACKGROUND OF THE INVENTION

Coupling of resonances of the front plate, back plate, and enclosed volume of air in hollow-bodied stringed instruments is ultimately responsible for such undesirable effects as bass-heavy tone and feedback. Yet, resonance is desirable because it provides the characteristic sound of hollow-bodied stringed instruments. Still, certain resonances are particularly troublesome. For example, it is low frequency resonance that is most responsible for bass-heavy tone and feedback in hollow-bodied guitars. The frequency of these offending resonances varies with guitar size but they are typically around 100 and 200 Hertz in a standard guitar.

Whether the low frequency resonance is that of the enclosed volume of air that is then communicated to the front and back plates or a coincidence of resonances of the respective plates, the coupling results in large amplitude displacement of these elements. The body, which essentially pumps air through the soundhole at low frequencies, thus naturally amplifies these notes resulting in bass-heavy tone. When a pickup is used, feedback tends to occur at these notes.

High frequency resonance, which is due not to coupling but to the resonance of one or the other of the plates, is not nearly so problematic and should be preserved as much as possible. Needed is a body for a hollow-bodied stringed instrument that simply and mechanically attenuates low frequency resonance while allowing high frequency resonance to contribute to the tone of the instrument.

### OBJECTS AND ADVANTAGES

The present invention alleviates to a great extent the aforementioned problems by providing a hollow-bodied stringed instrument body wherein at least one plate has at least one substantially free edge. This unique structure exploits the fundamental difference between high and low frequency resonances in hollow-bodied stringed instruments. The free edge attenuates low frequency coupling of the plate with the opposing plate and the enclosed volume of air while the portion of the body that opposes string tension provides mass, area, and stiffness to allow for high frequency resonance resulting in retention of the characteristic sound of a hollow-bodied stringed instrument.

The goal of prior art acoustic guitar design was to maximize resonance in order to maximize loudness. The tone imbalance in the form of bass-heavy tone that this created when the guitar was played acoustically was inevitable. The feedback that such tone imbalance caused when amplification was used was dealt with by the application of additional technology. In contrast to the goal of the prior art, the goal of the current invention is to balance tone by selectively reducing resonance. Such an approach has never been taken in the prior art.

Maximizing loudness requires leaving the lower bout of each plate intact since the lower bouts are the largest parts of each plate and each moves as a unit during low frequency resonance. Single soundholes in guitars are located at or above the division between the upper and lower bouts. While violin-style f-holes and the various other paired hole arrangements may extend slightly into the lower bout, no prior art instrument featured a substantially free edge in the lower bout.

This body for a hollow-bodied stringed instrument reduces bass-heavy tone mechanically. This is especially useful for large-bodied acoustic guitars where bass notes dominate when played acoustically. When used with a magnetic pickup, this reduced coupling reduces pickup motion and associated feedback thus making it ideally suited for application to hollow-bodied electric guitars as well.

When used with a pickup designed for acoustic instruments, it also reduces bass-heavy tone mechanically rather than requiring the electronic modification of tone often seen today. The choice of acoustic pickup need not hinge on electronic bass response modification or sensitivity to body vibration, both limiting factors in the prior art.

When used with a pickup designed for acoustic instruments, feedback is prevented structurally thus eliminating the common practice of deleting offending frequencies electronically with a notch filter. No frequencies are deleted; thus, no adjustment is required on the part of the musician to find and delete offending frequencies that might change in different environments. Low frequency resonance involves coupling and coupling is attenuated by the structure.

Every note is available to the musician and the tone of the instrument is controlled solely by the musician and accurately reproduced through the amplifier with substantially less feedback than in previous hollow-bodied instruments.

Varying the degree to which the free edge is free allows the instrument maker to fine tune the loudness of the bass notes relative to the higher notes when the instrument is played acoustically. When a pickup is used such flexibility translates into control over feedback.

Further objects and advantages of the invention will become apparent from a consideration of the drawings and ensuing description.

### SUMMARY

The above problems and others are at least partially solved and the above purposes and others realized in this new and improved body for a hollow-bodied stringed instrument including at least one plate having at least one substantially free edge. This arrangement reduces the coupling between the resonances of the plates and the enclosed volume of air at low frequencies while allowing high frequency resonance to contribute to the tone of the instrument.

### BRIEF DESCRIPTION OF THE DRAWINGS

Referring to the drawings:

FIG. 1 is a side view of a guitar with a body using curved shells and having no conventional side wall wherein the front plate includes the free edge.

FIG. 2 is a front view of a guitar with a body using curved shells and having no conventional side wall wherein the front plate includes the free edge.

FIG. 3 is a view of the inside of the front plate of the guitar showing the ribs.

FIG. 4 is an isometric view of a guitar with a body using curved shells and having no conventional side wall wherein the front plate includes the free edge.

### REFERENCE NUMERALS

1. guitar 7. free edge of front plate
2. head 8. hole
3. neck 9. bridge
4. strings 10. ribs
5. body 11. inside surface of front plate
6. frontplate 12. backplate

### DETAILED DESCRIPTION OF PREFERRED EMBODIMENT

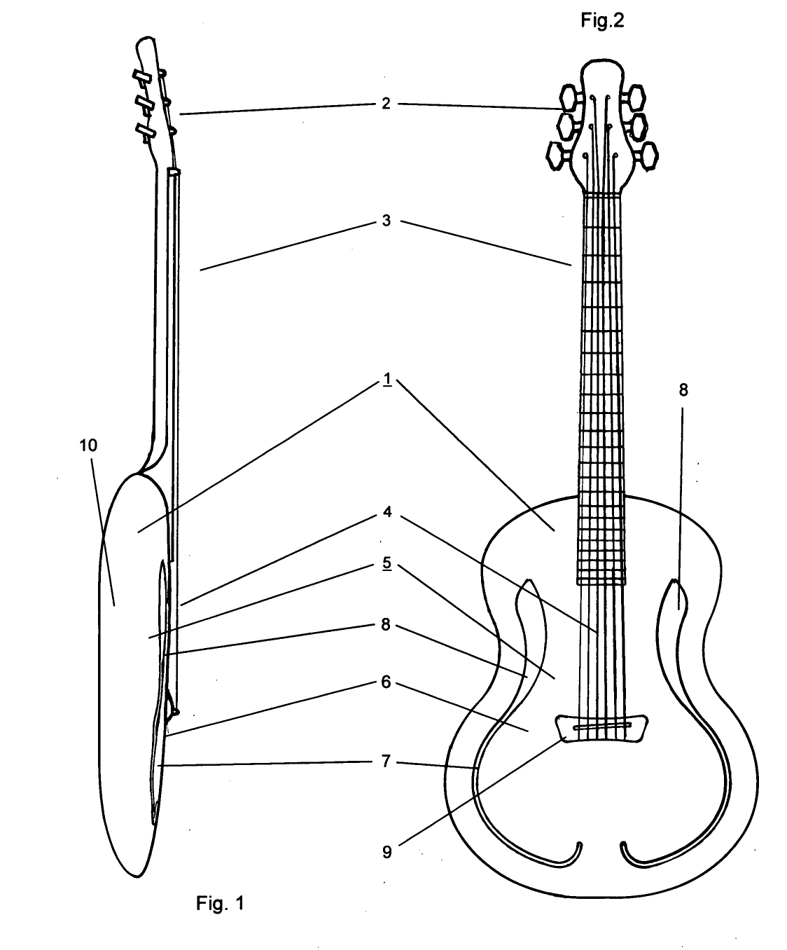

In its preferred embodiment the present body is illustrated in FIGS. 1 to 4 as applied to a guitar body with curved front and back plates and no conventional side wall wherein the curved top plate has the substantially free edge; it should be readily apparent, however, that in other embodiments the substantially free edge could alternatively be in the curved back plate or both plates and that the present invention is equally applicable to all hollow-bodied stringed instruments including flat-topped guitars and arched-topped guitars both with conventional side walls.

FIGS. 1 to 4 show a hollow-bodied stringed instrument comprising a guitar 1 having a head 2, neck 3, strings 4, and guitar body 5. The guitar body 5 is a soundbox in the form of a hollow body. The guitar body 5 includes front plate 6. Front plate 6 has substantially free edge 7 due to a selected number of holes 8. The substantially free edge 7 of front plate 6 preferably follows the shape of the outer edge of front plate 6. Front plate 6 is joined to a back plate 12 adhesively to form a guitar body 5. Bridge 9 is carried by front plate 6. The strings 4 extend from the head 2 along the neck 3 to the bridge 9. In the embodiment depicted in FIGS. 1 to 4, the guitar body 5 is made of wood.

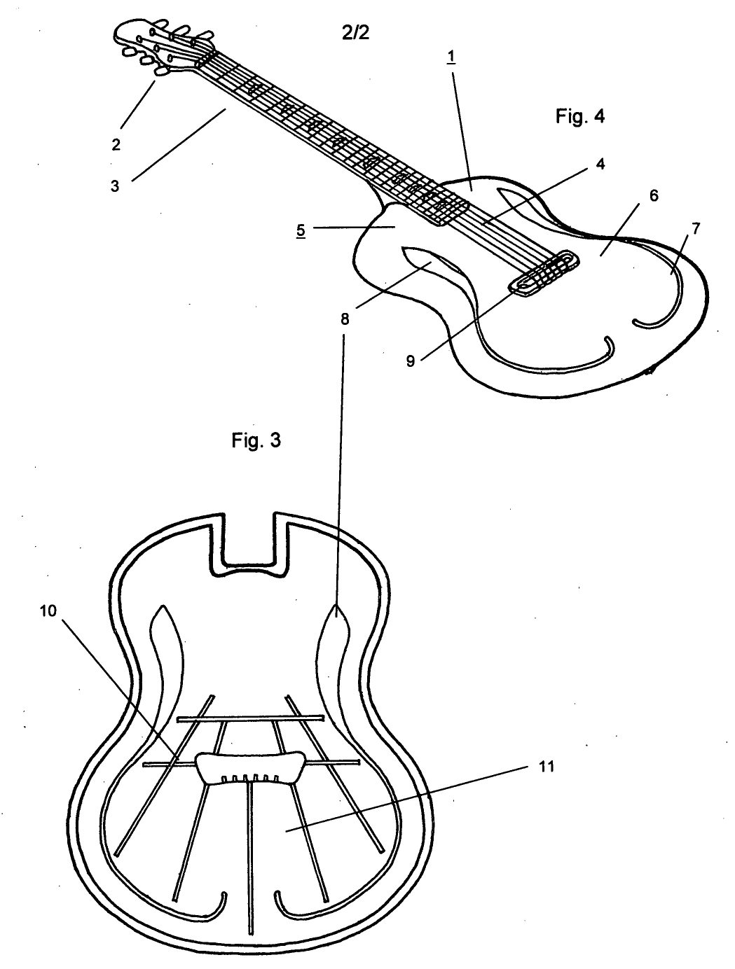

According to other embodiments, the guitar body 5 may be made of plastic, graphite or other appropriate materials. In the embodiment depicted in FIGS. 1 to 4, the number of holes 8 is two and they are elongated. According to other embodiments, the number and shapes of holes may vary. In the preferred embodiment, ribs 10 are transversely attached to the inside surface 11 of the top plate 6 as in FIG. 3. According to other embodiments, other means of support may be used.

### Operation of Preferred Embodiment

The relatively rigid peripheral portion of front plate 6 is adhesively connected to the back plate 12 and acts as a framework supporting the less rigid central portion of front plate 6 against string tension. Energy from one or more plucked strings is transmitted through the bridge 9 to the front plate 6 where it spreads in all directions in a deforming wave that causes front plate 6 to drive the surrounding air.

Generally, when the driving frequency is a resonant frequency common to front and back plates this results in large displacement of these elements and a natural amplification of such notes by the guitar body. However, in the current invention the substantially free edge 13 of the front plate 6 alters the physical characteristics of the front plate 6 to minimize the coincidence of resonant frequencies between front plate 6 and back plate 12 even if these components are made from the same material and have nearly identical dimensions. The deforming wave cannot advance when encountering the free edge 7 thus the boundary condition of much of the front plate 6 is effectively changed to free even though the peripheral portion is firmly attached to the back plate 12.

Generally, when the driving frequency is a resonant frequency of the enclosed volume of air the result is alternating expansion and contraction of the entire body. However, in the current invention the substantially free edge 7 of the front plate 6 alters the physical characteristics of the front plate 6 to minimize this characteristic breathing motion. In the prior art this breathing motion is so problematic that when an acoustic guitar is fitted with a pickup designed for such guitars and played through an amplifier, some sort of plug is often placed in the soundhole or the top plate is significantly stiffened to prevent feedback due to this motion. In the current invention no such measures are necessary. The enclosed volume of air can be exposed to resonant frequencies because the breathing motion is minimized by the substantially free edge.

The pattern and number of holes 8 creating the free edge 7 of the front plate 6 for the preferred embodiment were chosen to create a free edge in substantially all of the lower bout. The free edge 7 defines a large area for the center portion of the front plate 6 by being located a generally uniform and short distance from the outer edge of front plate 6. The large area of the front plate 6 which carries the bridge 9 and has ribs 10 providing stiffness allows the front plate 6 to act as a resonant front plate allowing this to color the tone of the instrument. These high frequency resonances are not dependent on coupling between the plates or resonance of the enclosed volume of air.

While two holes 8 creating a substantially free edge 7 on front plate 6 are shown and discussed, it is possible to vary the number and shapes of holes to adjust the following parameters: the extent to which the substantially free edge is free; the area of the front plate; the extent to which the lower bout contains a free edge; the degree to which the free edge is symmetric about the longitudinal axis of the front plate.

In the embodiment depicted in FIGS. 1 to 4, the portion of each hole that extends into the lower bout is made narrow in an attempt to create a free edge while minimizing the increase in total airflow through all holes.

### Ramifications

While there is shown and described the present preferred embodiment of the invention, it is to be distinctly understood that this invention is not limited thereto but may be variously embodied to practice within the scope of the following claims.

I claim:

1. An assembled hollow body for a stringed instrument, comprising:
a front plate supporting a bridge;
a back plate;
means for joining said front plate and said back plate to enclose a volume of air;
at least one hole of a selected shape in said front plate; and
a substantially free edge in the lower bout of said front plate;
whereby coupling between said front plate, said back plate, and said volume of air will be reduced.

2. A method of controlling the resonance and the resulting feedback of the hollow body of a stringed musical instrument having a front plate and a back plate, which comprises:
(a) carving a substantially free edge in the lower bout of said front plate; and
(d) assembling entire instrument including body, head, neck, stings, and bridge.
